(19) United States
(12) Patent Application Publication
(10) Pub. No.: US 2017/0068272 A1
(43) Pub. Date: Mar. 9, 2017

(54) Laptop computer case with integrated file storage and batteries

(71) Applicant: Erik Jens Loscalzo, Manhasset, NY (US)

(72) Inventor: Erik Jens Loscalzo, Manhasset, NY (US)

(21) Appl. No.: 15/330,312

(22) Filed: Sep. 3, 2016

Related U.S. Application Data
(60) Provisional application No. 62/283,651, filed on Sep. 4, 2015.

(51) Int. Cl. G06F 1/16; H04B 1/3888

(52) U.S. Cl. CPC G06F 1/1628; H04B 1/3888; G06F 1/1635; G06F 1/1656; G06F 1/1675; G06F 1/1684; G06F 1/1683

(57) ABSTRACT

A case, batteries and data storage are provided for an electronic device, comprising a casing defining its shape around the outer shape of the electronic device. The rechargeable battery cells and data storage are housed within the thickness of the case. An internal interface engages a corresponding interface on the electronic device to provide power and data communications to the electronic device. The case will be electronically coupled with the internal interface of the electronic device to transmit data to and from the case. The case will also provide integrated communication interfaces and possessors that can be used by the electronic device. The case has the unique ability to simultaneously use multiple electronic ports that exist on the user's device both for electronic communication and mechanical fastening between the device and case.

### FIELD

One embodiment relates to batteries and data storage within a case that mechanically fastens to the laptop using the existing electronic ports (USB, HDMI, power etc.) on opposing sides of the laptop and that interfaces with a laptop computer to provide extended battery life, additional data storage and protection for the laptop computer.

### BACKGROUND

Most laptop computers are powered by battery power sources. Such battery power sources are often housed within the laptop computer and can be recharged as needed. However, inure the consumer often gets much less time between charges than the manufacturer claims. This tends to limit the usefulness of the laptop computer since the user must find a power source to recharge the internal battery and wait until it is recharged.

Also, after a certain number of charge cycles, a battery will lose capacity and will not store as much energy. The consumer then faces the choice to replace the battery or continue using the laptop that now can power its self on battery for less time than when you originally bought the laptop computer. Oftentimes, it is not easy to replace the battery with in the laptop computer, as it may have to be disassembled in order to replace the battery.

Additionally consumers face another problems and that is the limited amount of files that can be stored on a laptop computer. Once the limit has been reached the user must delete files or disassemble the laptop to replace the Hard Drive, SSD etc. in order to increase the number of files that can be stored on the device. In some cases laptop computes don't allow for the file storage system to be changed forcing the consumer to buy another laptop computer.

Therefore, a way is needed to extend the time between charges of laptop computers and/or continue to power the laptop computer even after an internal power source has been depleted. Additionally, a way is needed to increase the storage in laptops to allow the user to keep an increased number of files.

### SUMMARY

According to one embodiment, this case for a laptop computer is provided comprising a casing and one or more rechargeable power cells. The one or more rechargeable power cells will be referred to as the battery. The casing may define a cavity that conforms, at least partially, to the outer shape of the laptop computer. Additionally, the casing may further define one or more access openings to mechanically attach to the laptop computer using openings on opposing sides and permit access to integrated interfaces (e.g. USB ports, Thunderbolt port, HDMI, audio jack, etc.) of the laptop computer.

The battery and data storage device (e.g. Hard Drive, Solid State Drive, etc.) may be housed within the thickness of the casing. The case will also include an internal interface and/or external interface. The internal interface will engage a corresponding interface on the laptop computer to provide power from the one or more rechargeable cells within the case to the laptop computer. The external interface will be electrically coupled to the internal interface in order to transmit signals from the laptop computer to an external case and vise versa to provide a data communications link. The external interface may further serve to recharge the battery.

The case may also include a display interface integrated into the case to display information to a user. Such display interface may allow expanding the display from the laptop computer. This display may be touchscreen and might mirror the display on the laptop computer. This user interface could include a user interface that would show the status of the components within the case.

The case may be constructed in a wedge like shape in order to make the keyboard position more ergonomic. By attaching this wedge shaped case to the bottom of the laptop computer this tilts the keyboard toward the user from the horizontal plain and makes typing more comfortable.

The case will provide additional recourses for the laptop computer for example additional battery capacity, additional file storage and a more ergonomic position for the laptop computer. In order to provide these extra capabilities the case uses existing electronic ports on the laptop computer in order to provide communications between the case and the laptop computer. These communications may include but are not limited to: electronic data transmission, power transmission, video transmission, and audio transmission. In addition to using these ports (e.g. USB ports, Thunderbolt port, HDMI, audio jack, etc.) for communications these ports are used as one of the primary mechanical fastening device for the case to stay on the laptop. By using ports on opposing sides of the laptop computer the case can be securely attached to the laptop computer.

### DESCRIPTION OF THE DRAWINGS

FIG. 1 illustrates a top view of how a laptop computer can be housed within the case. As can be appreciated from this figure, the case is shaped to closely wrap around the laptop computer and serves as a protective case for the laptop computer.

FIG. 2 illustrates a perspective view of the laptop computer with the case.

FIG. 3 illustrates a front view of the laptop computer with the case.

FIG. 4 illustrates a side view of the laptop computer with the case.

FIG. 5 illustrates a bottom view of the laptop computer with the case.

FIG. 6 illustrates a bottom perspective view of the laptop computer with the case.

FIG. 7 illustrates a perspective view of a case for a laptop computer according to one example. In this example, the case is shaped to receive or house a laptop computer within a contoured cavity. The case has an integrated rechargeable power cell capable of providing power to operate and/or recharge a laptop computer and a file storage system that can be assessed by the laptop computer.

FIG. 8 illustrates a perspective view of the case.

FIG. 9 illustrates a front view of the case.

FIG. 10 illustrates a side view of the case.

FIG. 11 illustrates a bottom view of the case.

FIG. 12 illustrates a bottom perspective view of the case.

FIG. 13 illustrates a detailed perspective view of the case.

FIG. 14 illustrates a block diagram for the electronic system. The electronic system may include a battery 104, an internal interface 100, an external interface 111, and charge level indicator 105. The internal interface 100 may be adapted to provide power to a laptop computer from the battery 104 as well as passing signal to/from the laptop computer to the external interface 111. The external interface 111 may allow recharging of the battery 104 as well as passing signals to/from the laptop computer via the internal interface 100. A switch 113 may allow switching power from the battery 104 to the laptop computer On and Off as desired. Also, a charge level indicator 105 displays the charge level of the battery 104. Additionally, recharging of the battery 104 may be done with either the charging port 103 or through wireless charging 102 when needed.

The one or more file storage systems 106/107 may also provide the laptop computer a means by which to store additional files, application, etc. This file storage system may effectively expand the file storage system in the laptop computer by providing a data communication link from the laptop computer to the internal interface in the case.

The case also operates as an extendible processing and/or interfacing platform for the laptop computer. The case may also include one or more processors 108/109 and/or one or more external interfaces 111. The one or more processors 108/109 may allow the laptop computer to be coupled to the internal interface 100 to extend its processing capabilities. For instance, the laptop computer may cause one or more applications to be executed on the one or more processors while using a user display on the laptop computer as an output interface. Additionally, the processors 108/109 may be purpose-specific processors that allow the laptop computer to perform particular tasks not otherwise possible on its own. For example, the processors 108 may provide analog-to-digital conversion, audio signal sampling, temperature measuring, etc., which may not be available to the standard laptop computer.

The one or more interfaces 108/109 may also provide the laptop computer a means by which to communicate or acquire signals. This external user interface 111 may effectively expand the communication interfaces available to the laptop computer by providing wired and/or wireless communication interfaces for various types of signals (e.g., audio, infrared, etc.).

The case 112 may also facilitate recharging of the battery. This function is controlled by the battery management system 101. For example, recharging may be carried out by a wireless charging device 102 that inductively or otherwise facilitates recharging of the battery. The battery may also be charged by a wired method. The battery management system will control how the batteries charge. The charge level indicator will then display to the user the status of the battery. This can be done through either LEDs or an informational electronic display.

In another example implementation, the case 112 may be adapted to function as a Gaming Processing Unit that may include the capability of turning the laptop computer into a real handheld gaming device with joysticks or large PSP/DS type of gaming buttons and communication devices. Consequently, the laptop computer may be configured to operate as an input and/or output interface (e.g., via a display on the laptop computer or case) for a game.

Another feature may be for one or more speakers to be included as part of the case. For instance a low-profile speaker may be housed within the back plane of the case so that the sound may be emitted from the bottom or sides of the case. When a laptop computer is inserted into the case and coupled to the case, it couples to an interface that electrically connects the speaker to the laptop computer. The laptop computer may send audio or sound signals to the speaker via an interface with the case. This allows a user to listen to audio stored in the laptop computer without the need, for headphones.

According to yet another feature, when the laptop computer is coupled to the case 112, it may cause one or more applications to execute on the processors 108/109. These applications may continue to operate or execute even if the laptop computer is removed or decoupled from the case 112. For example, the case may continue to collect data and wirelessly transmits the collected data to the laptop computer. This is possible since the processors 108/109 may be powered by the battery 104 and can be configured to operate whether or not the laptop computer is coupled to the case.

In some embodiments of the case 112 may also include an integrated display 110 or touch screen. For example, the integrated display may be on the outer surface of a section of the case. Alternatively, the integrated display may slide out from within the housing of the case. This integrated display 110 may allow displaying additional information or data to a user. The additional display screen may be electrically coupled to the laptop computer (via an interface) to allow the laptop computer to send images or video to the additional display screen.

According to another feature, the case may provide an external interface (e.g., Bluetooth wireless interface, USB ports, Display Ports, Thunderbolt Port, infrared port, etc.) that may allow the laptop computer mounted in the case and/or holster to communicate via that external interface. Thus the external interface may provide a different wireless interface than provided or supported by the internal system of the laptop computer.

An extendible communication and/or processing platform may be provided to the laptop computer by the case. For instance, a plurality of user external communication interfaces 111 may be coupled to the internal interface 100, wherein the laptop computer can transmit and receive signals via the communication interfaces. Similarly, at least one processor 108 may be coupled to the internal interface 100, and adapted to collect information via one or more external interfaces 111 of the case and provide the collected information to the laptop computer. At least one processor 108/109 may be adapted to execute one or more instructions under the control of the laptop computer. According to one feature, a display interface 110 may be integrated into the case to display information to a user.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

FIG. 15 illustrates a computer rendered perspective view of the case with the laptop computer.

FIG. 16 illustrates a computer rendered perspective view of the case with the laptop computer separated from the case.

FIG. 17 illustrates a computer rendered exploited view of the laptop computer 1701, case access panel 1702, file storage system 1703, batteries 1704 and case 1705.

FIG. 18 illustrates a computer rendered perspective view of the case with the file storage system and batteries mounted inside.

FIG. 19 illustrates a computer rendered perspective view of the case without the file storage system and batteries mounted inside.

FIG. 20 illustrates a computer rendered perspective view of the case with a zoomed in vertical slice of the case. The slice shows how the case mechanically grabs onto the case so that the case does not separate from the laptop computer. The slice is the only diagram that shows the USB ports and this detail was omitted from all of the other diagrams.

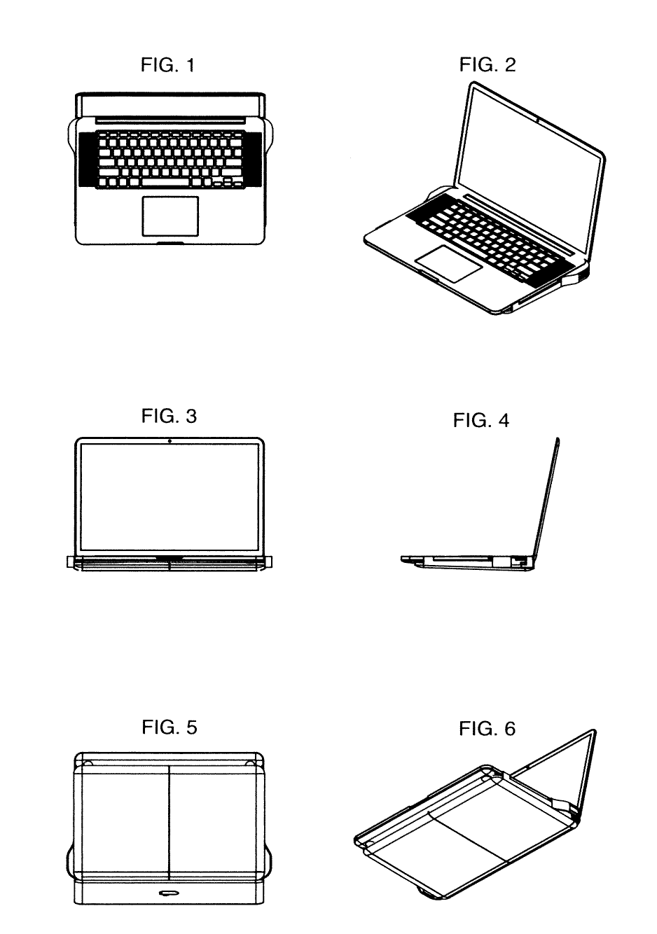

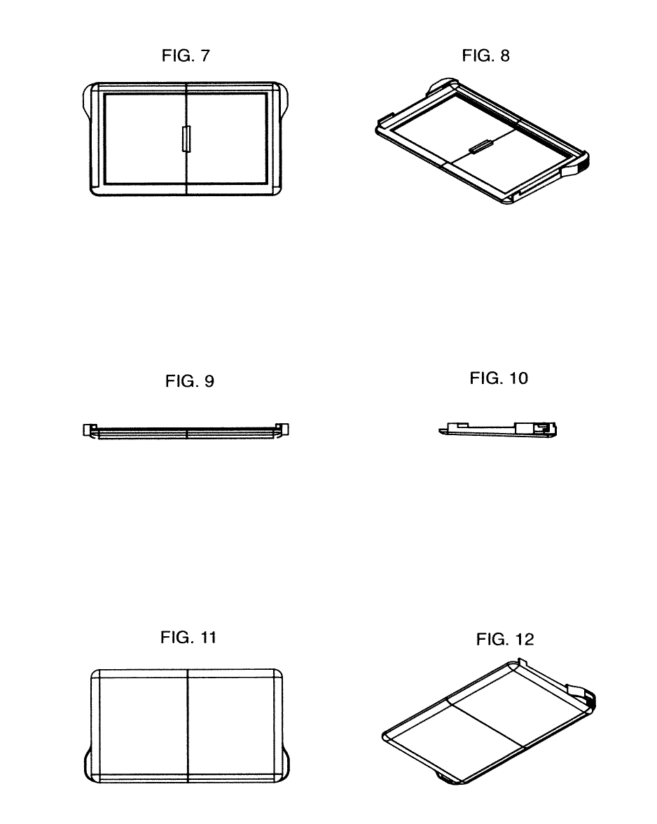

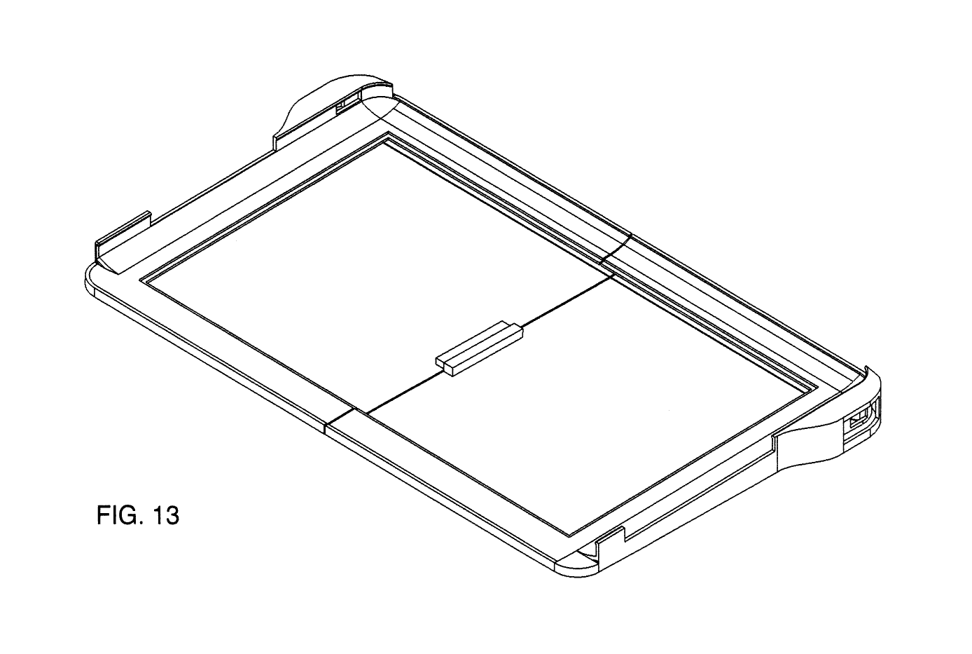

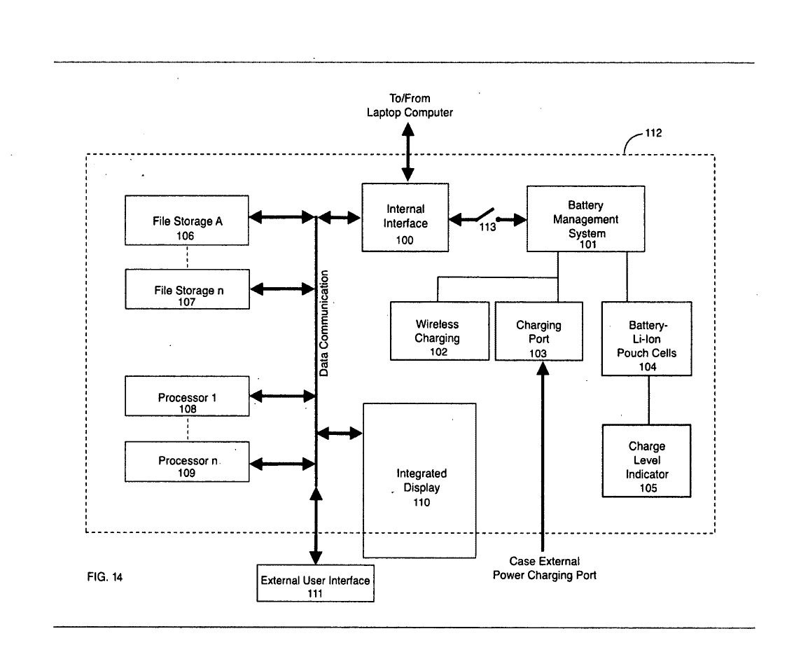

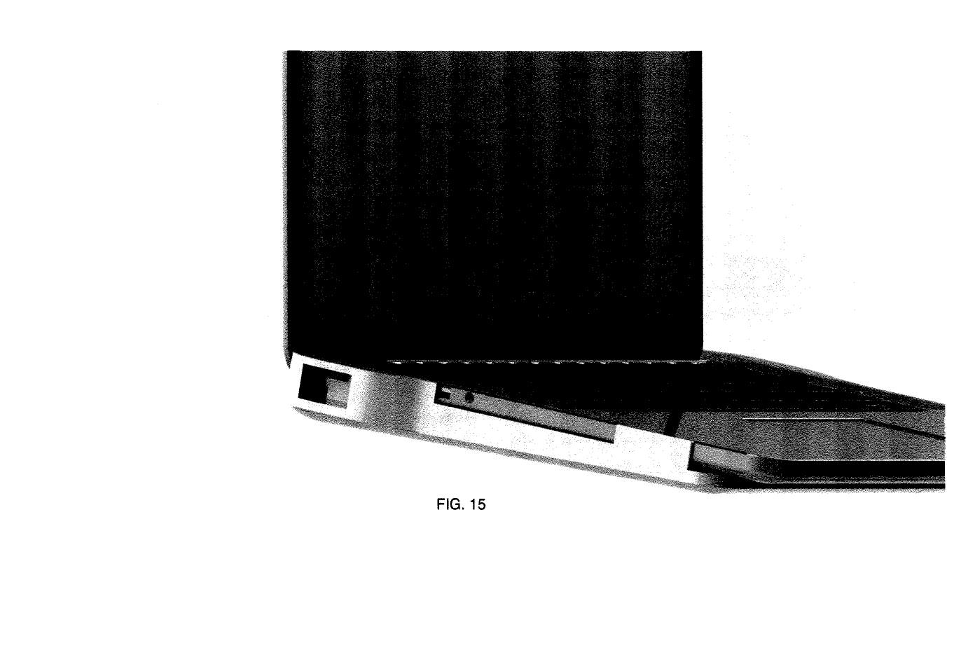

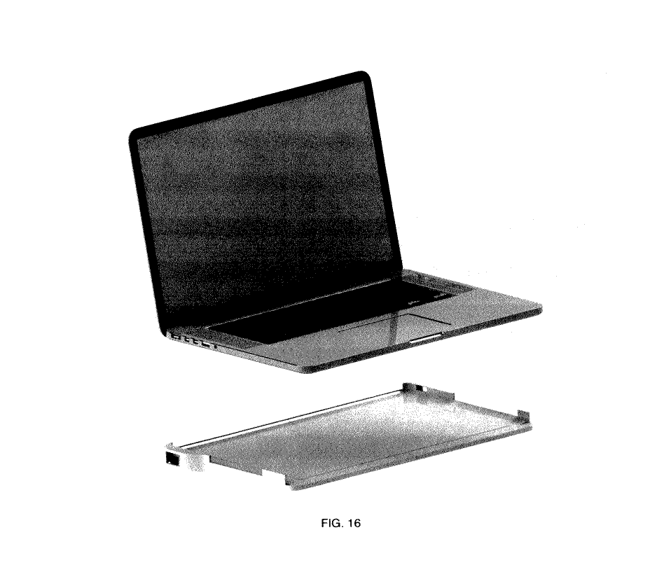

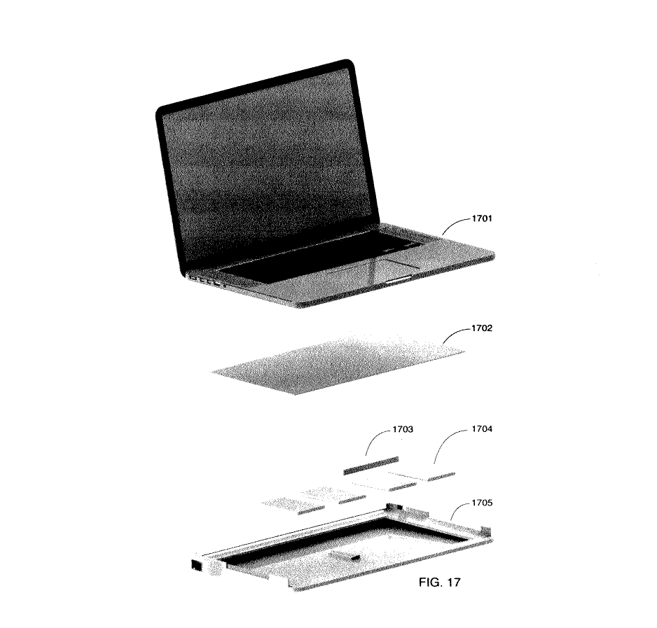

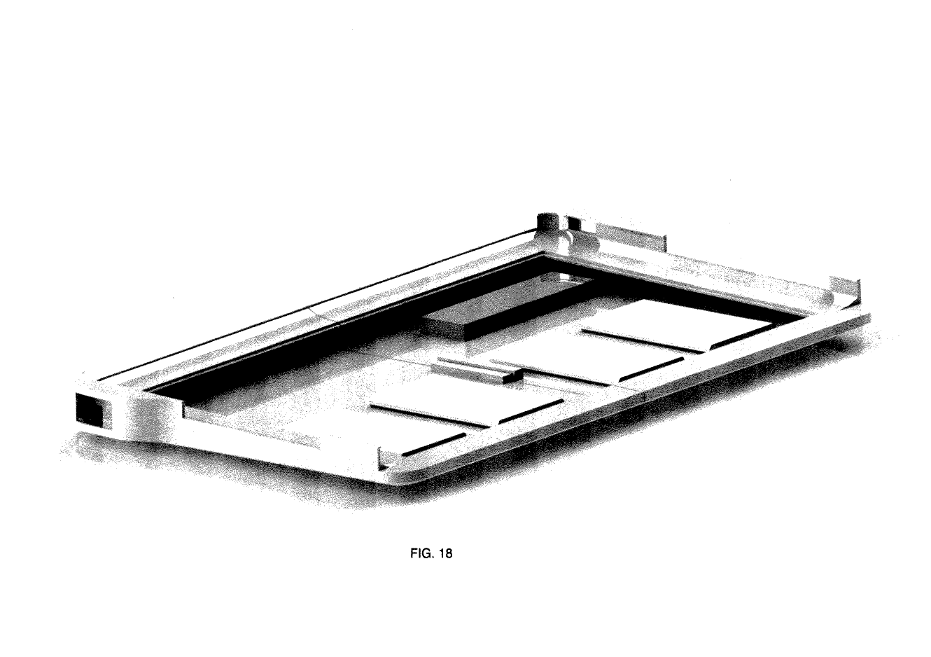

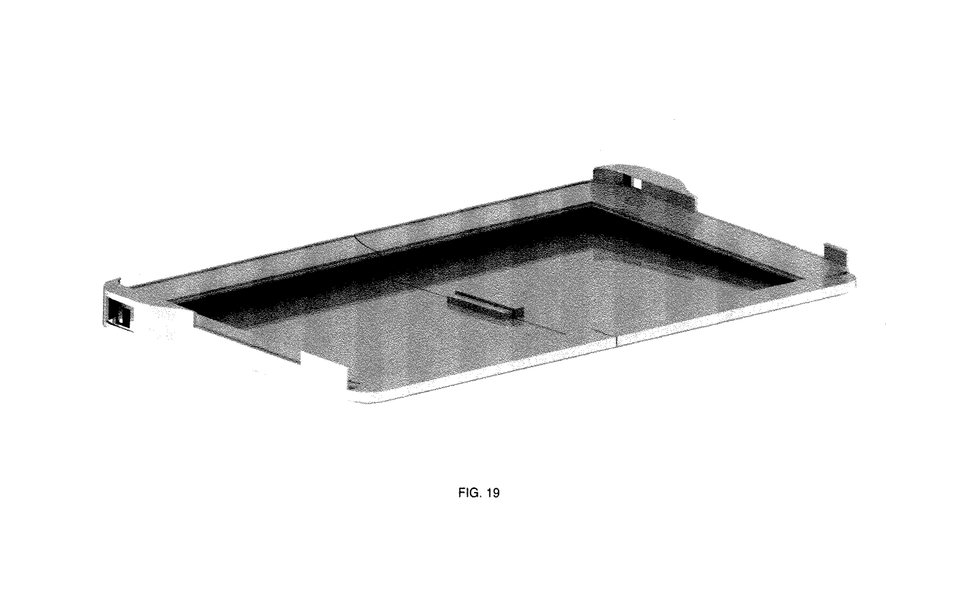

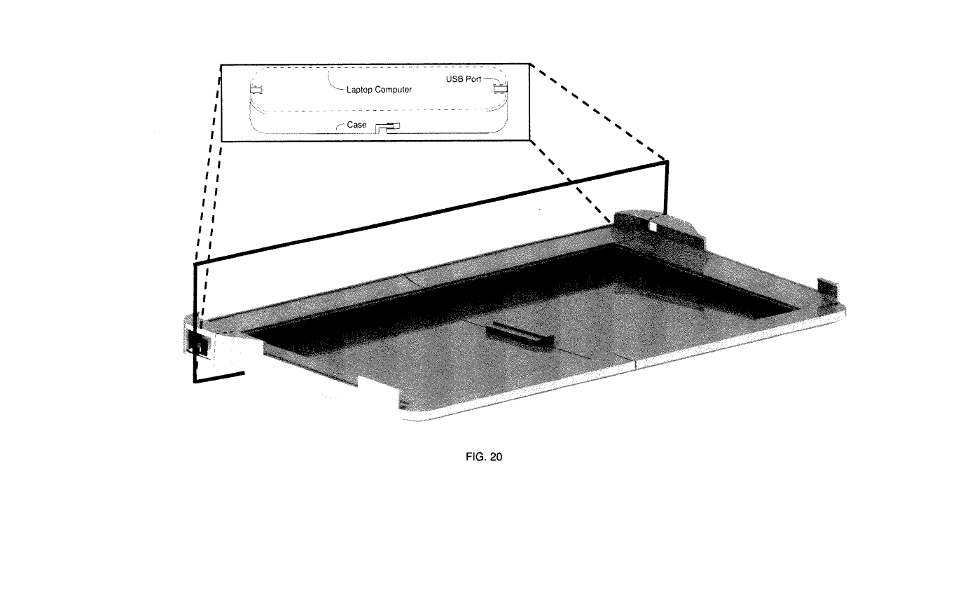

One or more of the features illustrated in FIGS. 1-20 may be rearranged and/or combined into a single component or embodied in several components. Additional components may also be added without departing from the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

### DESCRIPTION OF INVENTION

In one embodiment, this case for a laptop computer is provided comprising a casing and one or more rechargeable power cells. The one or more rechargeable power cells will be referred to as the battery. The casing may define a cavity that conforms, at least partially, to the outer shape of the laptop computer. Additionally, the casing may further define one or more access openings to mechanically attach to the laptop computer using openings on opposing sides and permit access to integrated interfaces (e.g. USB ports, Thunderbolt port, HDMI, audio jack, etc.) of the laptop computer.

The battery and data storage device (e.g. Hard Drive, Solid State Drive, etc.) may be housed within the thickness of the casing. This casing may be made of metal, plastic or another similar rigid material. The case will be made by injection molding or by milling from solid blocks of material depending on the manufacturing scale. The case will also include an internal interface and/or external interface. The internal interface will engage a corresponding interface on the laptop computer to provide power from the one or more rechargeable cells within the case to the laptop computer. The external interface will be electrically coupled to the internal interface in order to transmit signals from the laptop computer to an external case and vise versa to provide a data communications link. The external interface may further serve to recharge the battery.

The case may further comprise of a recharging device integrated within the case that wirelessly recharges the battery. This may include an inductive electrical recharging system that requires no direct contact or can recharge at a distance.

The case may also include additional communication interfaces between the battery cells and the laptop computer. For instance, a plurality of communication interfaces may be coupled to the internal interface, wherein the laptop computer can transmit and receive signals via the communication interfaces. Likewise, at least one processor within the case may be coupled to the internal interface and adapted to collect information via one or more interfaces of the case and provide the collected information to the laptop computer device. In one example, the processor may provide information to the computer about the estimated additional time the computer can operate on battery power.

The case may also include a display interface integrated into the case to display information to a user. Such display interface may allow expanding the display from the laptop computer. This display may be touchscreen and might mirror the display on the laptop computer. This user interface could include a user interface that would show the status of the components within the case.

According to one aspect, the thickness of the case may be approximately or substantially the same as the thickness of the laptop computer. For this purpose, the case may be slim and/or have an ergonomic shape so that it does not significantly increase the thickness and/or size of the device. This is so the laptop computer can be used with the case for extended periods of time since the case does not significantly increase the bulkiness of the laptop computer.

According to yet another aspect, the case may include a plurality of communication interfaces coupled to the internal interface of the laptop computer, wherein the laptop computer can transmit and receive signals via the communication interfaces in order to store user information (e.g. files, applications, documents etc.) on the storage device within the case. The case may also include at least one processor coupled to the internal interface and adapted to collect information via one or more of the plurality of communication interfaces and provide the collected information to the laptop computer.

The case will provide additional recourses for the laptop computer for example additional battery capacity, additional file storage and a more ergonomic position for the laptop computer. In order to provide these extra capabilities the case uses existing electronic ports on the laptop computer in order to provide communications between the case and the laptop computer. These communications may include but are not limited to: electronic data transmission, power transmission, video transmission, and audio transmission. In addition to using these ports (e.g. USB ports, Thunderbolt port, HDMI, audio jack, etc.) for communications these ports are used as one of the primary mechanical fastening device for the case to stay on the laptop. By using ports on opposing sides of the laptop computer the case can be securely attached to the laptop computer.

The case may be constructed in a wedge like shape in order to make the keyboard position more ergonomic. By attaching this wedge shaped case to the bottom of the laptop computer this tilts the keyboard toward the user from the horizontal plain and makes typing more comfortable.

### REFERENCES

| | | |
|---|---|---|
| 6,256,193 B1 | July 2001 | Janik |
| 7,480,139 B2 | January 2009 | Ryder |
| 8,390,255 B1 | March 2013 | Fathollahi |
| 9,088,029 B2 | July 2015 | Mophie, Inc. |
| 9,164,544 B2 | October 2015 | Sirpal |
| 0218445 A1 | November 2003 | Behar |

1. A case for any laptop computer comprising:
a case that surrounds and protects the laptop
a space within the case that houses the electronics
a battery housed within the case
an electronic file storage system housed within the case
a printed circuit board that contains a battery management system and an interface to electronically communicate with the laptop computer over the integrated ports on the laptop computer

2. A wedge shaped design that allows the computer to be in a more ergonomic position. This is done by inserting a wedge shaped tilting the base of the laptop away from the horizontal plane toward the user.

3. The case is secured to the laptop computer using electronic ports (e.g. USB ports, Thunderbolt port, HDMI, audio jack, etc.). These ports are also used for communications between the laptop computer and the electronics within the case. In some instances ports on opposing sides of the laptop will be used and a latching device will be used to insert female connectors into both ports on opposing sides of the laptop at the same time. The case also uses these connections as a means of mechanically attaching the case to the laptop computer.

4. The electronics within the case extend the abilities of the laptop computer in the following ways but not limited to:
Battery life—the case will include additional batteries that will allow the laptop computer to operate longer while not plugged into a wall outlet.
File Storage—the case will include a system to save additional files, application etc. This will be accomplished by having a Hard Drive or SSD within the case that will interface with the computer.
Power Delivery—the case may include additional ways to charge the laptop computer by inductive charging or wireless charging.
Port Adapter—The case may include additional ports that might not be found on the laptop computer
Monitor—the case may include a screen to display additional content to the user
